(19) United States
(12) Patent Application Publication
(10) Pub. No.: US 2010/0223850 A1
(43) Pub. Date: Sep. 9, 2010

(54) Safety device for entry/exit gates

(76) Inventor: Hsin-Ta Chen, Taipei County (TW)

Correspondence Address: Hsin-Ta Chen, P.O.Box 44-2049, Taipei, 10668, TW

(21) Appl. No.: 12/659,198

(22) Filed: Mar. 1, 2010

(30) Foreign Application Priority Data
Mar. 3, 2009 (TW) 098203143

(51) Int. Cl. E06B 3/38

(52) U.S. Cl. 49/49

(57) ABSTRACT

An entry/exit gate includes a case and a stop board is pivotably connected to the case and extends through a slot of the case. A driving unit is located in the case and pivots the stop board. A cap is pivotably connected to the case and located above the slot of the case. The cap is mounted to the stop board and is connected to a resilient member which provides a force to pull the stop board into the case. When the stop board is pivoted and extends out from the slot of the case, the top of the stop board pushes the inside of the cap so that the cap is pivoted and covers the gap between the stop board and the case. When the stop board is retracted into the case, the cap is pulled back by the resilient member.

### BACKGROUND OF THE INVENTION

(1) Field of the Invention

The present invention relates to a safety device, and more particularly, to a safety device for eliminating the gap between the stop board and the case of the gate when the stop board extends.

(2) Description of the Prior Art

A conventional entry/exit gate 20 is shown in FIG. 1 and generally is located at the entry and/or exit of a building to control the entry and exit of persons or even vehicles. The gate 20 comprises a case 21, a stop 22 and a driving unit 23. However, there are some shortcomings for the conventional gate 20, wherein the first shortcoming is that the gate 20 usually occupies a certain area which is expensive in some areas so that the case 21 is required to be minimized so as not to occupy the limited area. Therefore, the area of the stop board 22 has to be reduced accordingly so that the stop board can be accommodated in the case 21 when the gate 20 is opened. Nevertheless, the second shortcoming is that, if the stop board 22 is reduced its size, there will be a gap 24 as shown in FIG. 2 between the case 21 and the stop board 22. The gap 24 can be a safety problem when people passing through the gate 20. Therefore, how to develop a stop board 22 that can be cooperated with the minimized case 21 while the gap 24 can also be eliminated is the main purpose of the present invention.

The present invention intends to provide a safety device for entry/exit gates and the safety device can eliminate the gap between the stop board and the case while the case is minimized.

### SUMMARY OF THE INVENTION

The present invention relates to an entry/exit gate which comprises a case, and at least one stop board and a driving unit are located in the case. The at least one stop board movably extends through a slot of the case. A cap is pivotally connected to the case and located above the slot in the case. The cap has a mounting portion which is mounted to the at least one stop board, and the cap further has a pivotal portion and a connection member connected thereto. A fixing unit is connected to an inside of the case and located above the cap. A free end of the fixing unit has a hook. At least one resilient member is connected between the cap and the fixing unit. A first end of the at least one resilient member is connected to the connection member and a second end of the resilient member is connected to the hook so as to pull the cap toward the case.

The primary object of the present invention is to provide a cap which is pivotable together with the pivotal movement of the stop board so as to cover the gap between the stop board and the case.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the movement of the stop board of the conventional entry/exit gate;

FIG. 2 shows that a gap is defined between the reduced case and the reduced stop board of the conventional entry/exit gate;

FIG. 3 is a perspective view to show the entry/exit gate of the present invention;

FIG. 4 is a perspective view to show the cap of the safety device of the entry/exit gate of the present invention;

FIG. 5 shows that the stop board and the cap are received in the case of the entry/exit gate of the present invention;

FIG. 6A shows that the driving unit is going to pivot the stop board of the entry/exit gate of the present invention;

FIG. 6B shows that the driving unit pivots the stop board out from the slot of the entry/exit gate and the cap is pivoted out from the slot, and

FIG. 6C shows that the stop board of the entry/exit gate of the present invention fully extends out from the slot and the cap covers the gap between the stop board and the case.

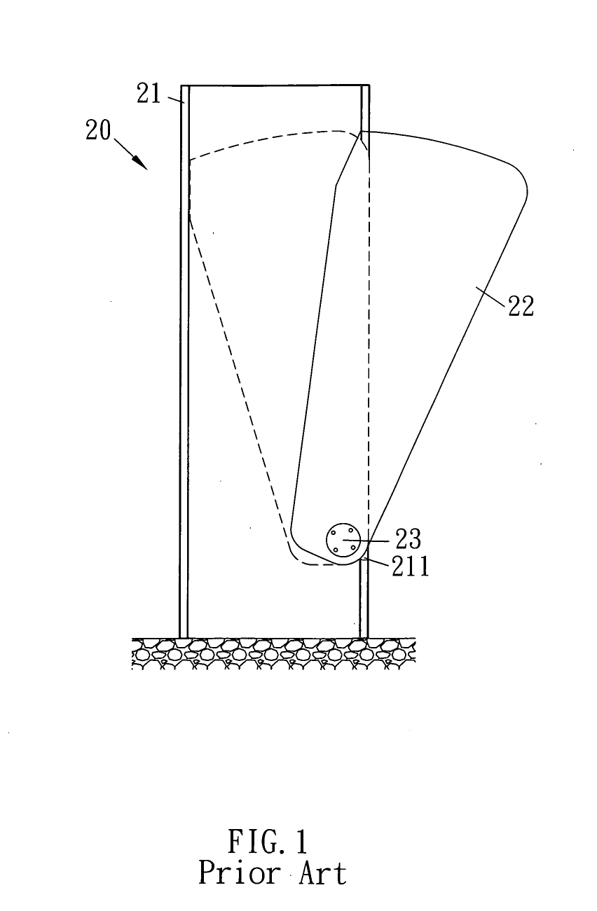

### DETAILED DESCRIPTION OF THE PREFERRED EMBODIMENTS

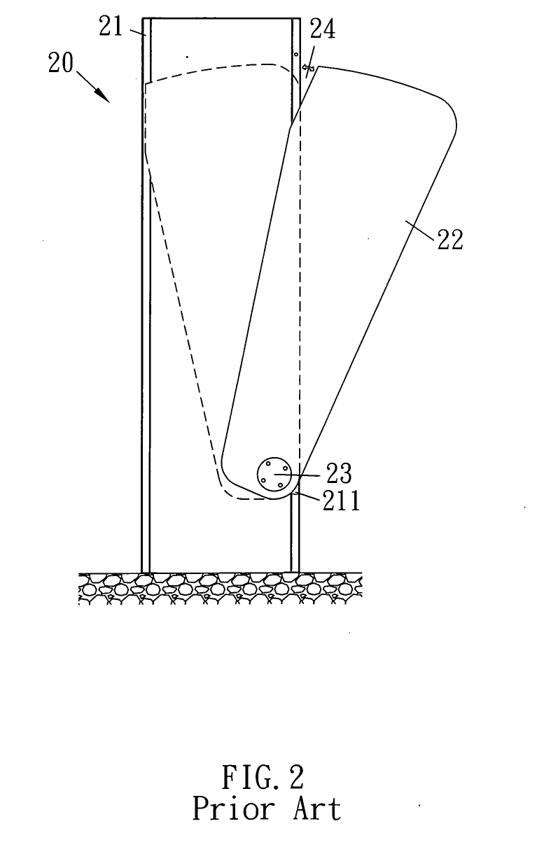

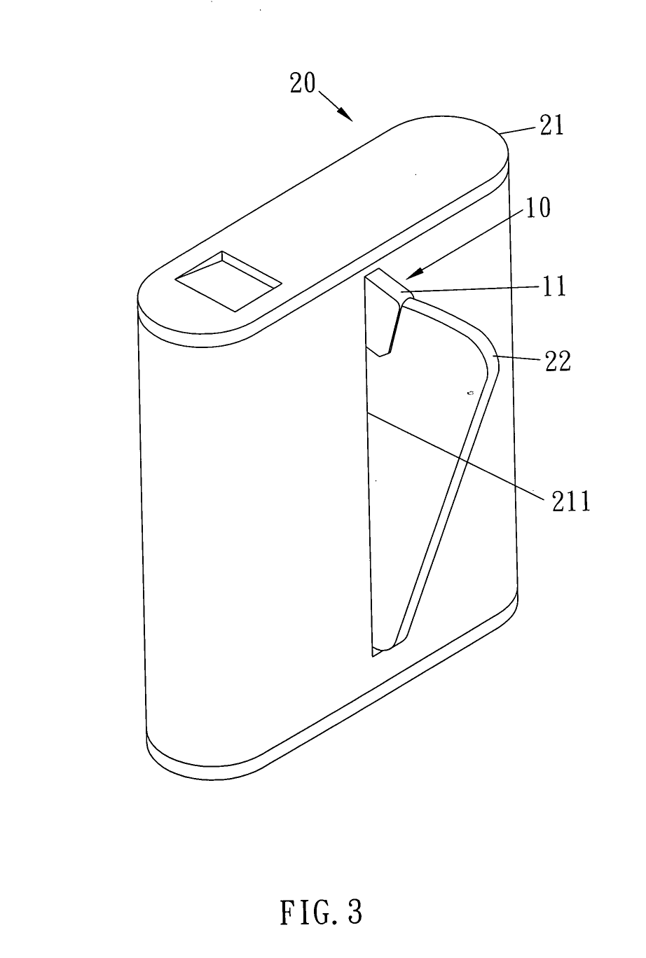

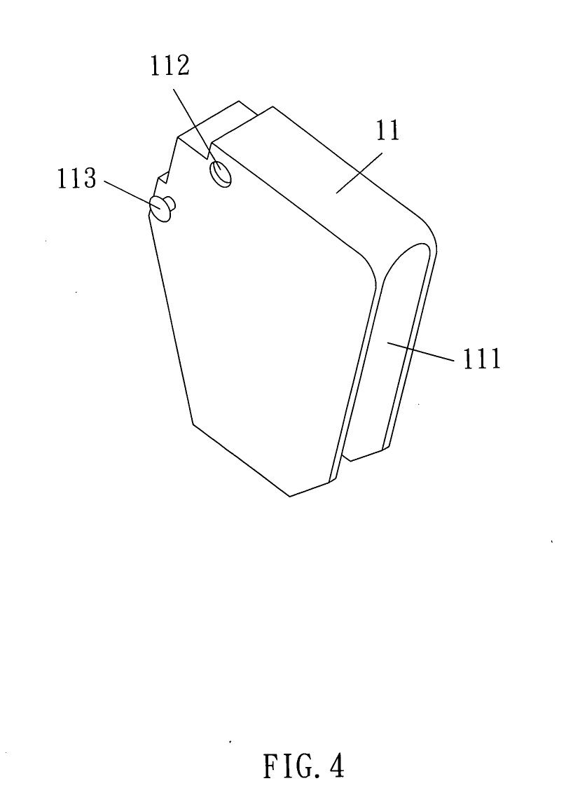

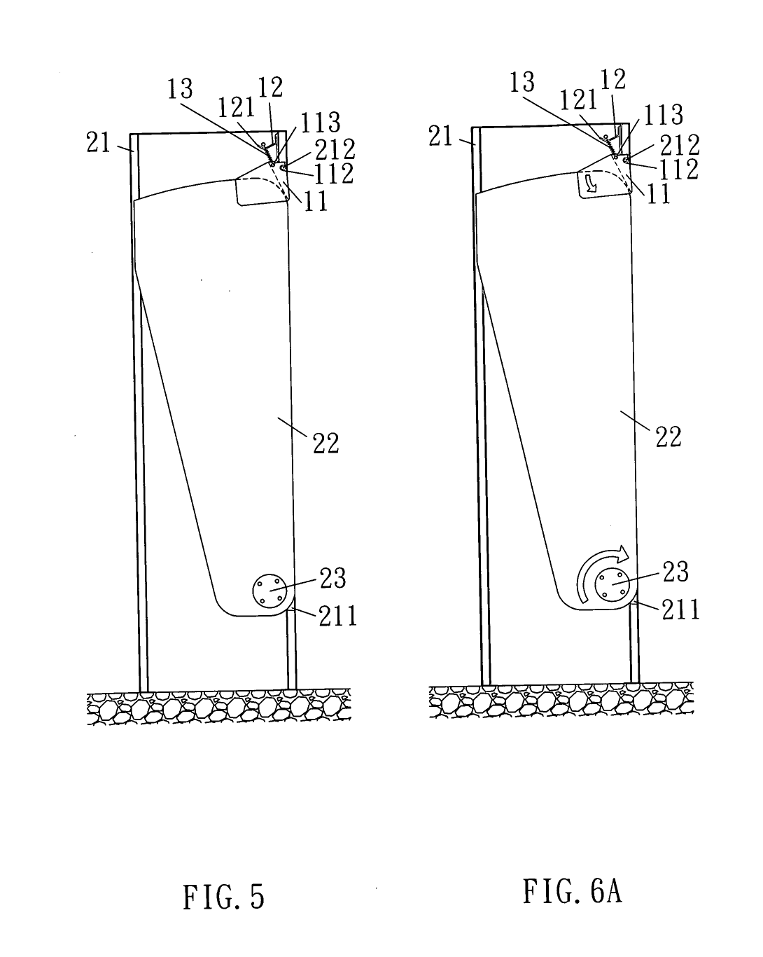

Referring to FIGS. 3 to 5, the entry/exit gate 20 of the present invention comprises a case 21, especially for the case 21 having a slot 211 which allows the stop board 22 to be pivoted through the slot 211. The stop board 22 and a driving unit 23 are located in the case 21 and the stop board 22 is driven to be pivoted through the slot 211 of the case 21. The case 21 is reduced its size and the stop board 22 is reduced so as to be cooperated with the reduced case 21. The present invention provides a safety device which is focused on the elimination of the gap 24 as disclosed in FIG. 2 between the stop board 22 and the case 21.

The safety device includes a cap 11 which has a mounting portion 111, in this embodiment, the mounting portion 111 is a recess in which a top of the stop board 22 is accommodated. In this embodiment, the cap 11 is located above the slot 211. The cap 11 has a pivotal portion 112 which are two holes in two side walls of the cap 11. Two connection members 113, only one is shown, extend from the two side walls of the cap 11.

The case 21 includes a fixing unit 12 connected to the inside of the case 21 and the fixing unit 12 is located above the cap 11. The case 21 further includes a pivot 212 which extends through the holes of the pivotal portion 112 of the cap 11 such that the cap 11 is pivotable through the slot 211. A free end of the fixing unit 12 has a hook 121. Two resilient members 13, only one is disclosed, are connected between the cap 11 and the fixing unit 12. A first end of each of the resilient members 13 is connected to the connection member 113 corresponding thereto and a second end of each of the resilient member 13 is connected to the hook 121 corresponding thereto, so as to pull the cap 11 toward the case 21. In this embodiment, the resilient members 13 are two links.

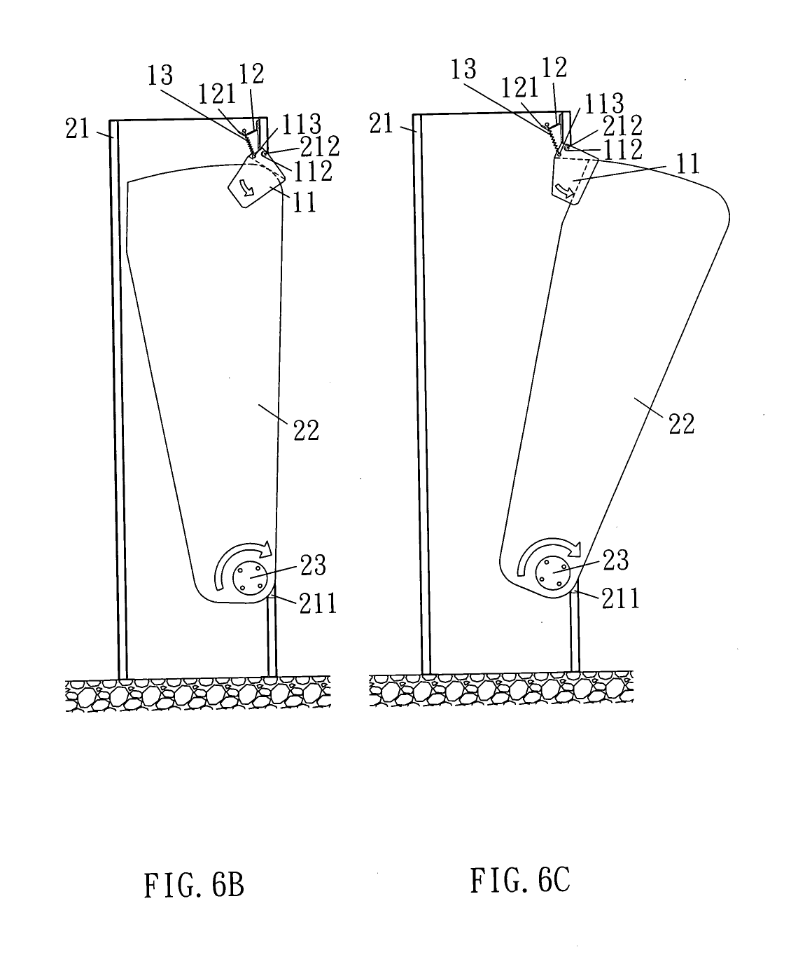

Referring to FIGS. 6A to 6C, when the driving unit 23 is activated by commands, it drives the stop board 22 and the top of the stop board 22 pushes the inside of the cap 11 so that the cap 11 is pivoted. The cap 11 is pivoted together with the pivotal movement of the stop board 22 by the contact between the inside of the cap 11 and the top of the stop board 22. When the stop board 22 fully extends out from the slot 211, the cap 11 covers the gap between the stop board and the case. When the stop board 22 is retracted into the case 21, the cap 11 is pulled back by the resilient members 13.

The cap 11 of the safety device covers the gap between the stop board 22 and the case 21 so that the safety concern for the reduced case 21 and stop board 22 of the entry/exit gate 20 can be improved.

While we have shown and described the embodiment in accordance with the present invention, it should be clear to those skilled in the art that further embodiments may be made without departing from the scope of the present invention.

What is claimed is:

1. An entry/exit gate comprising:
a case, at least one stop board and a driving unit located in the case, the at least one stop board movably extending through a slot of the case;
a cap pivotably connected to the case and located above the slot in the case, the cap having a mounting portion which is mounted to the at least one stop board, the cap having a pivotal portion and a connection member connected thereto;
a fixing unit connected to an inside of the case and located above the cap, a free end of the fixing unit having a hook, and
at least one resilient member connected between the cap and the fixing unit, a first end of the at least one resilient member connected to the connection member and a second end of the resilient member connected to the hook so as to pull the cap toward the case.

2. The gate as claimed in claim 1, wherein the pivotal portion of the cap is a hole and the case includes a pivot which extends through the hole such that the cap is pivotable through the slot.

3. The gate as claimed in claim 1, wherein the mounting portion is a recess.

4. The gate as claimed in claim 1, wherein the at least one resilient member is a link.
